(19) United States
(12) Patent Application Publication
(10) Pub. No.: US 2012/0243071 A1
(43) Pub. Date: Sep. 27, 2012

(54) ELECTRO-WETTING DISPLAY DEVICE

(75) Inventors: Hsin-Hung Lee, New Taipei City (TW); Yu-Hsiang Tsai, Hsinchu County (TW); Yun-Sheng Ku, Miaoli County (TW); Shu-Wei Kuo, New Taipei City (TW); Kuo-Lung Lo, New Taipei City (TW)

(73) Assignee: INDUSTRIAL TECHNOLOGY RESEARCH INSTITUTE, HSINCHU (TW)

(21) Appl. No.: 13/239,092

(22) Filed: Sep. 21, 2011

(30) Foreign Application Priority Data
Mar. 25, 2011 (TW) TW100110319

(51) Int. Cl. G02B 26/00

(52) U.S. Cl. 359/290

(57) ABSTRACT

An electro-wetting display device is provided. The device includes a first substrate and a second substrate disposed opposite thereto. A plurality of first electrodes and a plurality of corresponding second electrodes are disposed on the first substrate and face the second substrate. A barrier layer is between the plurality of first electrodes and the plurality of second electrodes, such that the plurality of first electrodes is electrically insulated from the plurality of second electrodes. A plurality of ribs is on the first substrate to form a plurality of pixel regions. A polar liquid and a non-polar liquid are between the first and second substrates. The barrier layer is between the polar liquid and at least one of the plurality of first electrodes and the plurality of second electrodes, and the non-polar liquid is in direct contact with the barrier layer in each pixel region.

### CROSS REFERENCE TO RELATED APPLICATIONS

This Application claims priority of Taiwan Patent Application No. 100110319, filed on Mar. 25, 2011, the entirety of which is incorporated by reference herein.

### BACKGROUND

1. Field of the Disclosure

The disclosure relates to a display device, and in particular to an electro-wetting display device.

2. Description of the Related Art

Along with developments in photoelectric techniques, various display devices have been disclosed. Electro-wetting display (EWD) devices are highly prized due to high light utilization, fast response time, low power consumption and high resolution characteristics.

A typical EWD device includes non-polar oil, a polar liquid, a hydrophobic layer, and a hydrophilic rib, wherein the non-polar oil is formed on the hydrophobic layer and separated by the hydrophilic rib. Moreover, the polar liquid is disposed on the non-polar oil. Operation of the electro-wetting display device is as follows. When no voltage is applied to the display device, the non-polar oil is smoothly paved on the hydrophobic layer, so that the color displayed is that of the non-polar oil. When a voltage is applied to the display device, the polar liquid is attracted by the induced charges formed on the hydrophobic layer, such that the non-polar oil moves to one corner of the hydrophobic layer, so that the color of an underlying substrate or the color of a backlight source is displayed.

PCT publication NO. WO 2005098524 provides an electro-wetting display device, wherein the display device includes a polar liquid, non-polar liquid, an upper substrate, a lower substrate and electrodes disposed on the lower substrate, wherein the polar liquid serves as a common electrode and has a conductor therein, thereby applying a voltage between the electrodes on the lower substrate and the conductor. However, since the electric field distribution is varied by the distance from the conductor, non-uniform electric field distribution occurs, thereby reducing the image quality of display devices.

In another conventional electro-wetting display device, a transparent common electrode is entirely formed on the upper substrate to prevent the non-uniform electric field distribution problem. However, the existence of the transparent common electrode may reduce transparency of the display device and limit design flexibility for selecting an upper substrate of the display device.

Accordingly, there exists a need in the art for development of a novel EPD device, capable of mitigating or addressing the above-described problems.

### BRIEF SUMMARY

A detailed description is given in the following embodiments with reference to the accompanying drawings. Electro-wetting display devices are provided. An exemplary embodiment of an electro-wetting display device comprises a first substrate and a second substrate disposed opposite thereto. A plurality of protrusions is disposed on the first substrate. A plurality of first electrodes and a plurality of second electrodes corresponding thereto are disposed on the first substrate and face the second substrate, wherein the plurality of second electrodes corresponds to the plurality of protrusions and each first electrode is disposed between adjacent protrusions. A barrier layer covers the plurality of first electrodes and the plurality of second electrodes and is disposed between the plurality of first electrodes and the plurality of second electrodes. A plurality of ribs is disposed on the first substrate to form a plurality of pixel regions, wherein each pixel region corresponds to one of the plurality of first electrodes and one of the plurality of second electrodes. A polar liquid and a non-polar liquid are disposed between the first and second substrates, wherein the non-polar liquid is in direct contact with the barrier layer in each pixel region.

Another exemplary embodiment of an electro-wetting display device comprises a first substrate and a second substrate disposed opposite thereto. A plurality of first electrodes and a plurality of second electrodes corresponding thereto are disposed on the first substrate and face the second substrate. A barrier layer is disposed on the first substrate and between the plurality of first electrodes and the plurality of second electrodes. A plurality of ribs is disposed on the first substrate to form a plurality of pixel regions, wherein each pixel region corresponds to one of the plurality of first electrodes and one of the plurality of second electrodes, and the second electrode in each pixel region is disposed above the corresponding first electrode to form an overlapping region as viewed from a top-view perspective therebetween. A polar liquid and a non-polar liquid are disposed between the first and second substrates, wherein the non-polar liquid is in direct contact with the barrier layer in each pixel region.

Yet another exemplary embodiment of an electro-wetting display device comprises a first substrate and a second substrate disposed opposite thereto. A plurality of first electrodes and a plurality of second electrode thick layers corresponding thereto are disposed on the first substrate and face the second substrate. A barrier layer covers the plurality of first electrodes and the plurality of second electrode thick layers and is disposed between the plurality of first electrodes and the plurality of second electrode thick layers. A plurality of ribs is disposed on the first substrate to form a plurality of pixel regions, wherein each pixel region corresponds to one of the plurality of first electrodes and one of the plurality of second electrode thick layers. A polar liquid and a non-polar liquid are disposed between the first and second substrates, wherein the non-polar liquid is in direct contact with the barrier layer in each pixel region.

### BRIEF DESCRIPTION OF DRAWINGS

The invention can be more fully understood by reading the subsequent detailed description and examples with references made to the accompanying drawings, wherein:

FIG. 1A is a cross section of an exemplary embodiment of an electro-wetting display device when a voltage is not applied thereto according to the disclosure;

FIG. 1B is a cross section of another exemplary embodiment of an electro-wetting display device when a voltage is not applied thereto according to the disclosure;

FIG. 1C is a cross section of the electro-wetting display device shown in FIG. 1A when a voltage is applied thereto;

FIG. 2A is a cross section of an exemplary embodiment of an electro-wetting display device when a voltage is not applied thereto according to the disclosure;

FIG. 2B is a cross section of the electro-wetting display device shown in FIG. 2A when a voltage is applied thereto;

FIG. 3A is a cross section of an exemplary embodiment of an electro-wetting display device when a voltage is not applied thereto according to the disclosure;

FIG. 3B is a cross section of an exemplary embodiment of an electro-wetting display device when a voltage is not applied thereto according to the disclosure;

FIG. 3C is a cross section of an exemplary embodiment of an electro-wetting display device when a voltage is not applied thereto according to the disclosure; and

FIG. 3D is a cross section of the electro-wetting display device shown in FIG. 3A when a voltage is applied thereto.

### DETAILED DESCRIPTION

The following description is of the best-contemplated mode of carrying out the invention. This description is provided for the purpose of illustrating the general principles of the disclosure and should not be taken in a limiting sense. The scope of the disclosure is best determined by reference to the appended claims.

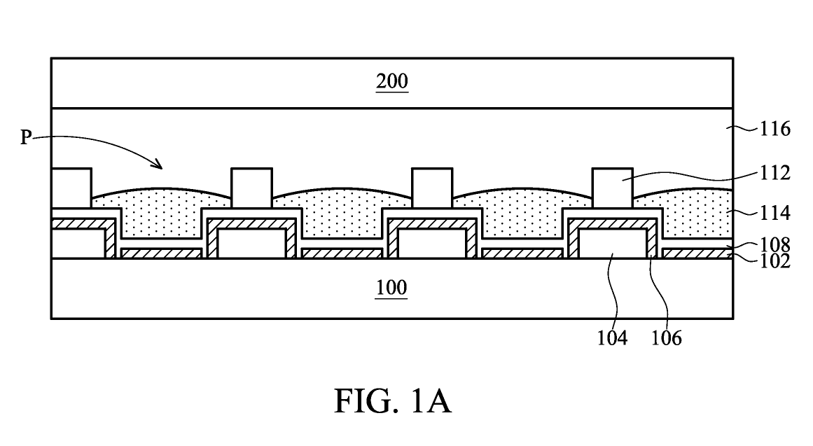

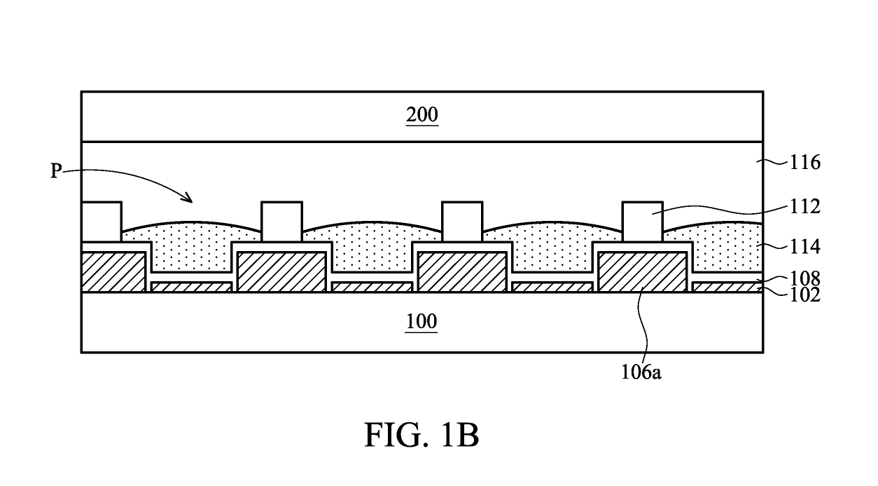

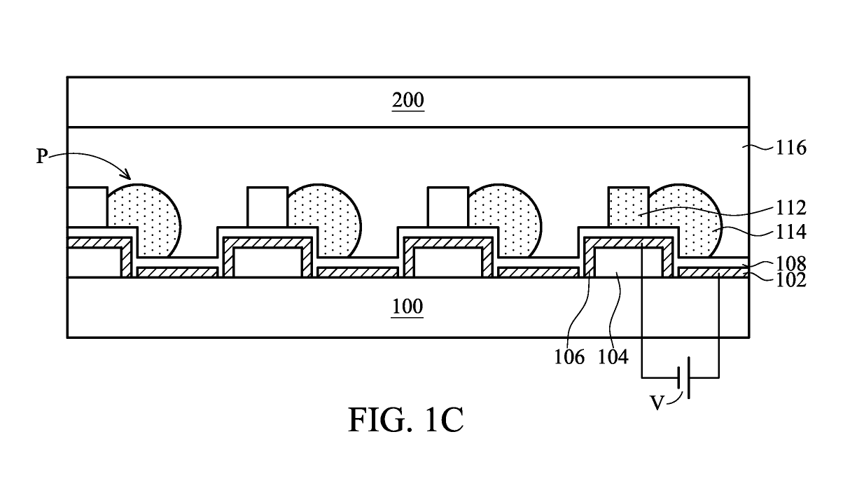

Referring to FIG. 1A, FIG. 1A illustrates a cross section of an exemplary embodiment of an electro-wetting display device when a voltage is not applied thereto according to the disclosure. The electro-wetting display device comprises a first substrate 100 and a second substrate 200 disposed opposite thereto. In the embodiment, the first substrate 100 and/or the second substrate 200 may comprise glass, metal or plastic.

In some embodiments, the first substrate 100 and/or the second substrate 200 may be a flexible substrate comprising, for example, poly(ethyleneterephthalate) (PET), polyethylenenaphthalate (PEN), polycarbonate (PC), polyethersulfone (PES) or polyimide (PI), or combinations thereof.

A plurality of protrusions 104 is disposed on the first substrate 100 and faces the second substrate 200. The plurality of protrusions 104 may comprise silicon oxide, silicon nitride, silicon oxynitride, Al₂O₃, Ta₂O₃, TiO₂, BaTiO₃, polyvinylidene difluoride (PVDF), or combinations thereof.

A plurality of first electrodes 102 is disposed on the first substrate 100 and faces the second substrate 200. In the embodiment, each first electrode 102 is disposed between the adjacent protrusions 104. A plurality of second electrodes 106 is also disposed on the first substrate 100 and corresponds to the plurality of first electrodes 102 and the plurality of protrusions 104. Moreover, each second electrode 106 is conformally disposed on the sidewall and upper surface of a corresponding protrusion 104. At least one of the plurality of first electrodes 102 and the plurality of second electrodes 106 serves as a common electrode, and the other serves as a pixel electrode.

In one embodiment, the plurality of first electrodes 102 and/or the plurality of second electrodes 106 may comprise silver, indium tin oxide (ITO), fluorine tin oxide (FTO) or poly(ethylenedioxythiophene) (PEDOT). Moreover, each first electrode 102 and/or each second substrate 106 may be rectangular, square, triangular, circular, or elliptic as viewed from a top-view perspective.

Unlike the conventional electro-wetting display device, since each first electrode 102 and each second substrate 106 both are disposed on the first substrate 100, an additional device (not shown), such as a solar cell, color filter, light guide plate or flat panel display may be disposed on the second substrate 200 and opposite to the first substrate 100.

A first barrier layer 108 is disposed on the first substrate 100 and covers the plurality of first electrodes 102 and the plurality of second electrodes 106 on the plurality of protrusions 104. The first barrier layer 108 between the plurality of first electrodes 102 and the plurality of second electrodes 106 makes each first electrode 102 electrically insulated from a corresponding second electrode 106.

In the embodiment, the first barrier layer 108 on a sidewall of each protrusion 104 has a thickness less than that of the first barrier layer 108 on an upper surface of each protrusion 104 due to the step height between the plurality of protrusions 104 and the first substrate 100. The first barrier layer 108 may comprise a material which is the same as or different from that of the plurality of protrusions 104. For example, the barrier substrate 108 may be a dielectric/insulating layer comprising hydrophobic surface, such as a treated hydrophobic surface and comprise silicon oxide, silicon nitride, silicon oxynitride, Al₂O₃, Ta₂O₃, TiO₂, BaTiO₃, polyvinylidene difluoride (PVDF), or combinations thereof. Additionally, the first barrier layer 108 may be a hydrophobic layer comprising dielectric/insulating materials, such as fluoro-containing polymer (for example, “Cytop” (ASAHI Glass CO., LTD) or “Cytonix” (Cytonix corporation)), polytetrafluoroethene (PTFE) or diamond-like carbon. Moreover, the first barrier layer 108 may also be a hybrid layer comprising a stack of a hydrophobic layer and a dielectric/insulating layer.

A plurality of first ribs 112 is disposed on the first substrate 100 and corresponds to the first barrier layer 108 above each protrusion 104 to form a plurality of pixel regions P, wherein each pixel region P corresponds to one of the plurality of first electrodes 102 and one of the plurality of second electrodes 106. Moreover, the plurality of first ribs 112 may also be disposed on a non-electrode region. In the embodiment, the plurality of first ribs 112 may comprise hydrophilic material, such as positive photoresist, negative photoresist, photosetting resin or thermosetting resin. Moreover, each first rib 112 may be rectangular, square, triangular, circular, or elliptic as viewed from a top-view perspective. In one embodiment, the first barrier layer 108 is patterned before forming the plurality of first ribs 112, to partially expose the plurality of second electrodes 106 or the first substrate 100 under the first barrier layer 108. The plurality of first ribs 112 is disposed on the exposed plurality of second electrodes 106 or the exposed first substrate 100, such that the first barrier layer 108 surrounds each first rib 112.

A polar liquid 116 and a first non-polar liquid 114 are disposed between the first and second substrates 100 and 200, wherein the first barrier layer 108 is disposed between the polar liquid 116 and the plurality of first electrodes 102 and/or the plurality of second electrodes 106, such that the polar liquid 116 is electrically insulated from the plurality of first electrodes 102 and/or the plurality of second electrodes 106. Moreover, the first non-polar liquid 114 is in each pixel region P formed by the plurality of first ribs 112 and is in direct contact with the first barrier layer 108. In one embodiment, the polar liquid 116 may comprise water or alcohols and may be a colorless or colored (e.g., white) liquid. Moreover, an electrolyte, such as KCl or NaCl, may be added into the polar liquid 116 to increase the ion conductivity.

The first non-polar liquid 114 may be a color (e.g., red, green, blue, black, cyan, magenta or yellow) liquid and comprise silicon oil, C₁₀-C₁₆ alkane (e.g., decane, dodecane, tetradecane or hexadecane), dye or pigment.

Referring to FIG. 1B, FIG. 1B illustrates a cross section of another exemplary embodiment of an electro-wetting display device when a voltage is not applied thereto according to the invention. Elements in FIG. 1B that are the same as those in FIG. 1A are labeled with the same reference numbers as in FIG. 1A and are not described again for brevity. In the embodiment, the electro-wetting display device is similar to that as shown in FIG. 1A, and the difference is that a plurality of second electrode thick layers 106a is used instead of the plurality of second electrodes 106 and the plurality of protrusions 104 (shown in FIG. 1A). The first barrier layer 108 covers the plurality of first electrodes 102 and the plurality of second electrode thick layers 106a and is disposed on the plurality of first electrodes 102 and the plurality of second electrode thick layers 106a. Moreover, each pixel region P corresponds one of the plurality of first electrodes 102 and one of the plurality of second electrode thick layers 106a.

Referring to FIG. 1C, which illustrates a cross section of the electro-wetting display device shown in FIG. 1A when a voltage is applied thereto. In one embodiment, the plurality of first electrodes 102 may serve as a common electrode and each second electrode 106 is electrically connected to a pixel electrode (not shown) or a corresponding terminal in a thin film transistor array (not shown), such that a driving voltage V is applied between each first electrode 102 and the corresponding second electrode 106 when the electro-wetting display device is operated, wherein the first non-polar liquid 114 shrinks and closes to each first rib 112. In another embodiment, the plurality of second electrodes 106 may serve as a common electrode and each first electrode 102 is electrically connected to a pixel electrode (not shown) or a corresponding terminal in a thin film transistor array (not shown).

The desired gray levels for displaying can be provided by applying various driving voltages V to control the aperture ratio of the first non-polar liquid 114. According to foregoing embodiments, since additional devices can be disposed on the exterior of the second substrate 200, the design flexibility for the second substrate 200 of the electro-wetting display device can be increased. Moreover, since the plurality of first electrodes 102 and the plurality of second electrodes 106/second electrode thick layers 106a both are disposed on the same substrate (i.e., first substrate 100), they can be formed simultaneously by a laser or lithography process, thereby simplifying the manufacturing steps. Additionally, since no electrode is formed on the second substrate 200, the light transmission for the electro-wetting display device can be increased.

Since each first electrode 102 corresponds to one second electrode 106, non-uniform electric field distribution can be avoided. Moreover, since the second electrode 106 is formed on the protrusion 104 (as shown in FIG. 1A) or since the use of the second electrode thick layer 106a (as shown in FIG. 1B), the lateral electric filed applied between each first electrode 102 and the corresponding second electrode 106/second electrode thick layer 106a can pass through a relatively thin dielectric layer (i.e., the first barrier layer 108 on the sidewall of the second electrode 106/second electrode thick layer 106a). As a result, an increase of the driving voltage V can be avoided. Moreover, the relatively thick first barrier layer 108 on the upper surface of the second electrode 106/second electrode thick layer 106a can be used for preventing the polar liquid 116 from being electrolyzed due to tunneling effect.

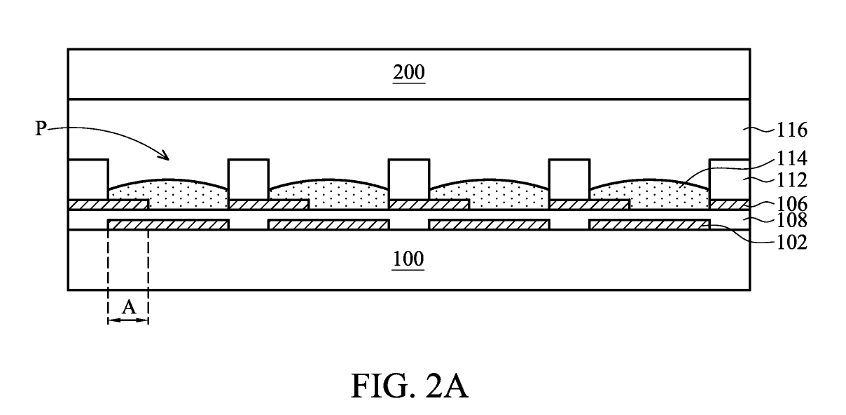

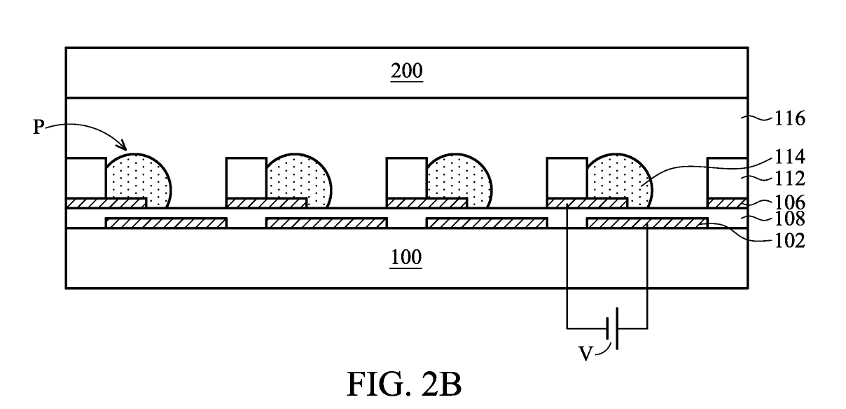

Referring to FIG. 2A, FIG. 2A illustrates a cross section of another exemplary embodiment of an electro-wetting display device when a voltage is not applied thereto according to the invention. Elements in FIG. 2A that are the same as those in FIG. 1A are labeled with the same reference numbers as in FIG. 1A and are not described again for brevity. Unlike the electro-wetting display device shown in FIG. 1A, the electro-wetting display device of the embodiment does not have the plurality of protrusions 104 (shown in FIG. 1A). The second electrode 106 in each pixel region P is disposed on the first barrier layer 108 above the corresponding first electrode 102, and there is an overlapping region A as viewed from a top-view perspective between each second electrode 106 and the corresponding first electrode 102.

Referring to FIG. 2B, which illustrates a cross section of the electro-wetting display device shown in FIG. 2A when a voltage is applied thereto. A driving voltage V is applied between each first electrode 102 and the corresponding second electrode 106 when the electro-wetting display device is operated. A relatively low electric field is generated at the overlapping region A as viewed from a top-view perspective due to shielding effect, and thus the shrunk first non-polar liquid 114 in each pixel region P closes to the same side of each first rib 112. As a result, the non-polar liquid can be controlled to shrink along a specific direction by the use of the electrodes with a vertical stack arrangement. In one embodiment, an area ratio of the overlapping region A as viewed from a top-view perspective to a corresponding pixel region P is not less than ⅕, thereby inducing a suitable shielding effect, such that each first non-polar liquid 114 can close to the same side of the corresponding first rib 112.

According to foregoing embodiments, since additional devices can also be disposed on the exterior of the second substrate 200, the design flexibility for the second substrate 200 of the electro-wetting display device can be increased. Moreover, since the plurality of first electrodes 102 and the plurality of corresponding second electrodes 106 both are disposed on the same substrate (i.e., first substrate 100), the manufacturing steps can be simplified, the light transmission for the electro-wetting display device can be increased, and the non-uniform electric field distribution can be avoided. Moreover, since the non-polar liquid can be controlled to shrink along a specific direction by the use of the electrodes with vertical stack arrangement, the non-polar liquid in each pixel region has a substantially the same aperture ratio, thereby increasing image quality.

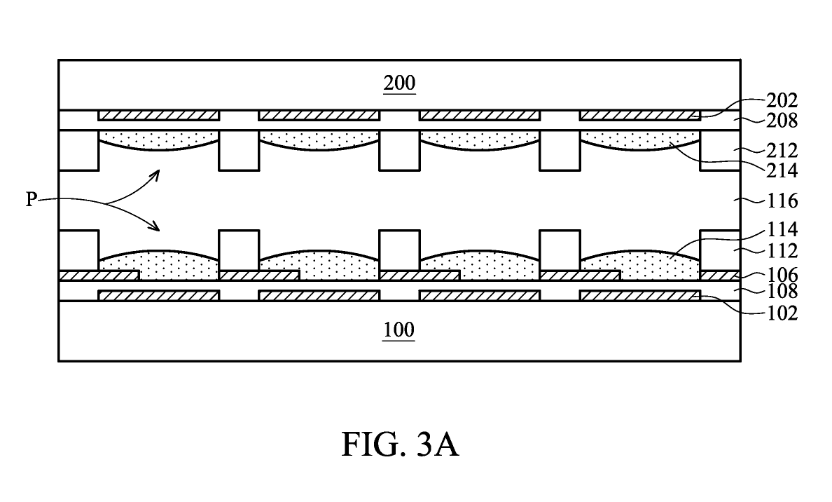

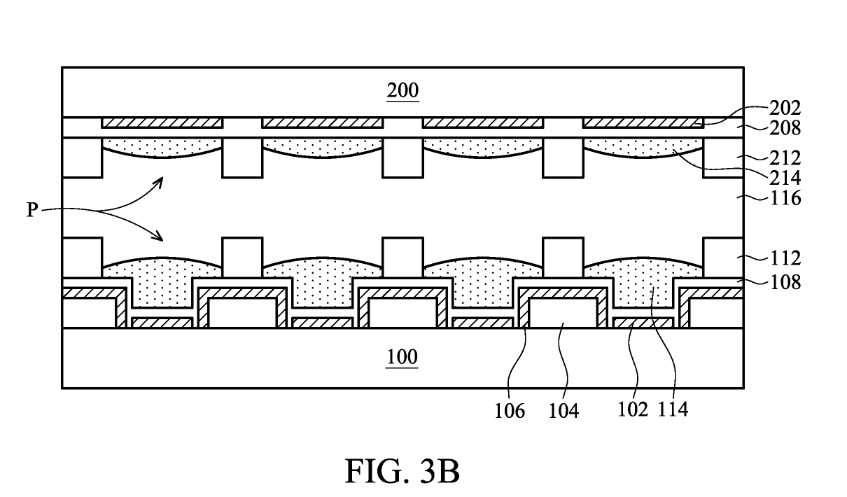

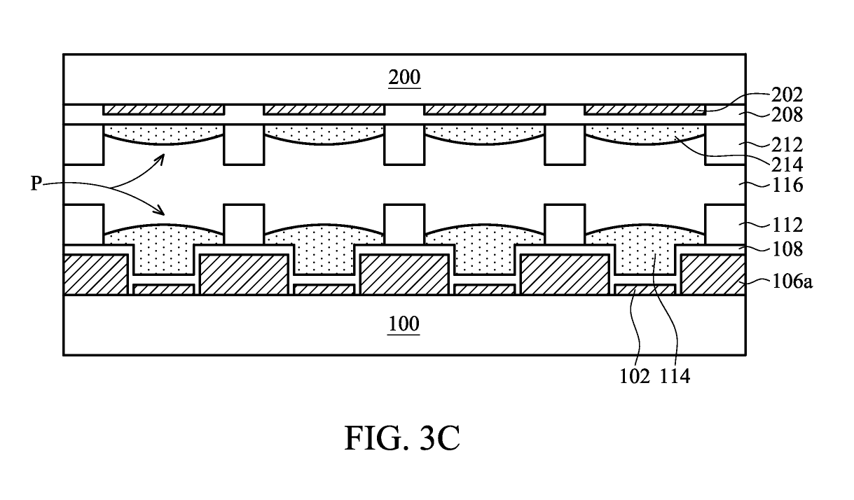

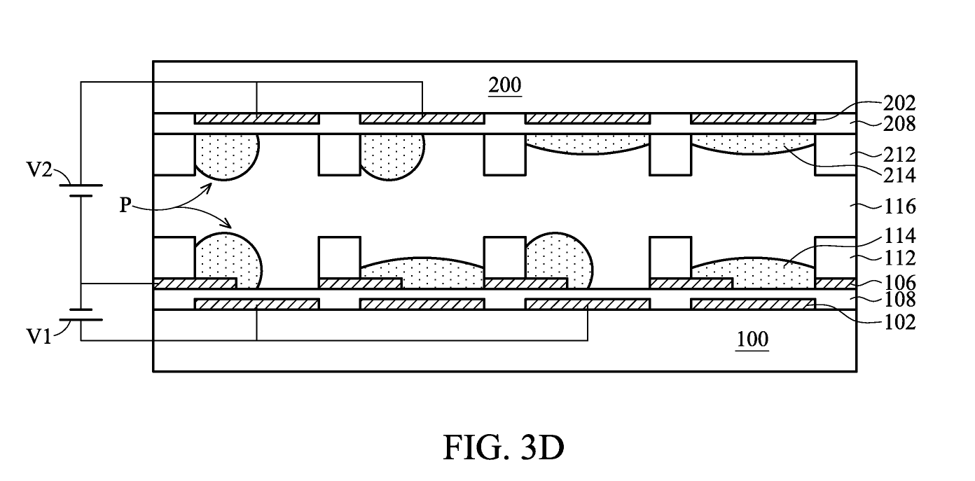

Referring to FIG. 3A, FIG. 3A illustrates a cross section of another exemplary embodiment of an electro-wetting display device when a voltage is not applied thereto according to the invention. Elements in FIG. 3A that are the same as those in FIG. 2A are labeled with the same reference numbers as in FIG. 2A and are not described again for brevity. Unlike the electro-wetting display device shown in FIG. 2A, the electro-wetting display device of the embodiment further comprises a plurality of third electrodes 202 disposed on the second substrate 200 and facing the first substrate 100. The plurality of third electrodes 202 corresponds to the plurality of first electrodes 102 on the first substrate 100. In one embodiment, the plurality of third electrodes 202 may comprise the same or similar materials as that of the plurality of first electrodes 102 and/or the plurality of second electrodes 106. Moreover, each third electrode 202 may be rectangular, square, triangular, circular, or elliptic as viewed from a top-view perspective.

In the embodiment, a second barrier layer 208 is disposed on the second substrate 200 and covers the plurality of third electrodes 202. A plurality of second ribs 212 is disposed on the second barrier layer 208 on the second substrate 200 and faces to the plurality of first ribs 112, wherein each pixel region P corresponds to one of the plurality of third electrodes 202. The plurality of second ribs 212 may comprise the same or similar materials as that of the plurality of first ribs 112. Moreover, each second rib 212 may be rectangular, square, triangular, circular, or elliptic as viewed from a top-view perspective. Moreover, the plurality of second ribs 212 may also be disposed on a non-electrode region. In one embodiment, the second barrier layer 208 is patterned before forming the plurality of second ribs 212, to partially expose the plurality of third electrodes 202 or the second substrate 200 under the second barrier layer 208. The plurality of second ribs 212 is disposed on the exposed plurality of third electrodes 202 or the exposed second substrate 200, such that the second barrier layer 208 surrounds each second rib 212.

In some embodiments, a plurality of fourth electrodes (not shown) can be additionally disposed on the second substrate 200, wherein the position relationship among the plurality of third electrodes 202, the plurality of fourth electrodes, and the second barrier layer 208 are corresponded to the position relationship among the plurality of first electrodes 102, the plurality of second electrodes 106, and the first barrier layer 108 on the first substrate 100. Moreover, the second barrier layer 208 makes the polar liquid 116 electrically insulated from the plurality of third electrodes 202. The second barrier layer 208 may comprise the same or similar materials as that of the first barrier layer 108.

A second non-polar liquid 214 is disposed between the first and second substrates 100 and 200, wherein the second non-polar liquid 214 is in each pixel region P formed by the plurality of second ribs 212 and is in direct contact with the second barrier layer 208. The second non-polar liquid 214 may be a colored (e.g., red, green, blue, black, cyan, magenta or yellow) liquid and comprise silicon oil, C₁₀-C₁₆ alkane (e.g., decane, dodecane, tetradecane or hexadecane), dye or pigment. In one embodiment, the first non-polar liquid 112 in different pixel regions P or the second non-polar liquid 212 in different pixel regions P may have the same or different colors. In another embodiment, the first non-polar liquid 112 and the second non-polar liquid 212 in the same pixel region P may have the same or different colors.

Although the arrangement of the plurality of first electrodes 102, the plurality of second electrodes 106, and the first barrier layer 108 on the first substrate 100 in the electro-wetting display device shown in FIG. 3A is the same as that of the electro-wetting display device shown in FIG. 2A, the arrangement of the plurality of first electrodes 102, the plurality of second electrodes 106, and the first barrier layer 108 on the first substrate 100 in the electro-wetting display device shown in FIG. 3A can be instead of that of the electro-wetting display device shown in FIG. 1A in another embodiment (as shown in FIG. 3B), such that each first electrode 102 is disposed between the adjacent protrusions 104. Each second electrode 106 is disposed on the first substrate 100 and corresponds to one first electrode 102 and one protrusion 104. The first barrier layer 108 is disposed on the first substrate 100 and covers the plurality of first electrodes 102 and the plurality of second electrodes 106 on the plurality of protrusions 104.

In another embodiment (as shown in FIG. 3C), the arrangement of the plurality of third electrodes 202 and the second barrier layer 208 on the second substrate 200 of the electro-wetting display device is the same as that of the electro-wetting display device shown in FIG. 3A. However, the arrangement of the plurality of first electrodes 102, the plurality of second electrodes 106, and the first barrier layer 108 on the first substrate 100 in the electro-wetting display device shown in FIG. 3C is the same as that of the electro-wetting display device shown in FIG. 1B, such that each first electrode 102 is disposed between the adjacent second electrode thick layers 106a. The first barrier layer 108 is disposed on the first substrate 100, covers the plurality of first electrodes 102 and the plurality of second electrode thick layers 106a, and is between each first electrode 102 and the corresponding second electrode thick layer 106a.

Referring to FIG. 3D, FIG. 3D illustrates a cross section of the electro-wetting display device shown in FIG. 3A when a voltage is applied thereto. In the embodiment, the plurality of second electrodes 106 may serve as a common electrode and each first electrode 102 is electrically connected to a pixel electrode (not shown) or a corresponding source in a thin film transistor array (not shown). Each third electrode 202 is electrically connected to another pixel electrode (not shown) or a corresponding source in another thin film transistor array (not shown). A driving voltage V1 is applied between some first electrodes 102 and the corresponding second electrodes 106 and a driving voltage V2 is applied between some third electrodes 202 and the corresponding second electrodes 106 when the electro-wetting display device is operated, wherein the driving voltage V1 may the same as or different from the driving voltage V2. As a result, the aperture ratio of the first non-polar liquid 114 and/or the second non-polar liquid 214 can be controlled by applying driving voltages V1 and V2 thereto. In other embodiments, the plurality of first electrodes 102 and the plurality of third electrodes 202 may serve as a common electrode and each second electrode 106 is electrically connected to a pixel electrode (not shown) or a corresponding source in a thin film transistor array (not shown).

According to foregoing embodiments, since each first electrode 102 corresponds to one second electrode 106, the non-uniform electric field distribution can be avoided. Moreover, since the first non-polar liquid 114/second non-polar liquid 214 can be controlled to shrink along a specific direction by the use of a vertical stack arrangement of the first electrode 102/third electrode 202 and the second electrode 106, image quality can be increased. Additionally, since the pixel regions P can be controlled by two thin film transistor arrays, full color displaying for the electro-wetting display device can be accomplished by the color mixture of the first non-polar liquid 114 and the second non-polar liquid 214.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electro-wetting display device, comprising:
a first substrate and a second substrate disposed opposite thereto;
a plurality of protrusions disposed on the first substrate;
a plurality of first electrodes and a plurality of second electrodes corresponding thereto, disposed on the first substrate and facing the second substrate, wherein the plurality of second electrodes corresponds to the plurality of protrusions and each first electrode is disposed between adjacent protrusions;
a first barrier layer covering the plurality of first electrodes and the plurality of second electrodes and disposed between the plurality of first electrodes and the plurality of second electrodes;
a plurality of first ribs disposed on the first substrate to form a plurality of pixel regions, wherein each pixel region corresponds to one of the plurality of first electrodes and one of the plurality of second electrodes; and
a polar liquid and a first non-polar liquid disposed between the first and second substrates, wherein the first non-polar liquid is in direct contact with the first barrier layer in each pixel region.

2. The device of claim 1, wherein the first barrier layer is disposed between the polar liquid and at least one of the plurality of first electrodes and the plurality of second electrodes.

3. The device of claim 1, wherein the first barrier layer covering a sidewall of the plurality of second electrodes has a thickness less than that of the first barrier layer covering an upper surface of the plurality of second electrodes.

4. The device of claim 1, wherein the plurality of protrusions comprises silicon oxide, silicon nitride, silicon oxynitride, Al₂O₃, Ta₂O₃, TiO₂, BaTiO₃, polyvinylidene difluoride (PVDF), or combinations thereof.

5. The device of claim 1, wherein the second substrate further comprises a solar cell, color filter, light guide plate or flat panel display thereon.

6. The device of claim 1, wherein one of the plurality of first electrodes and the plurality of second electrodes serves as a common electrode and the other serves as a pixel electrode.

7. The device of claim 1, further comprising:
a plurality of third electrodes disposed on the second substrate and facing the first substrate;
a second barrier layer disposed on the second substrate and covering the plurality of third electrodes;
a plurality of second ribs disposed on the second substrate and aligning to the plurality of first ribs, wherein each pixel region corresponds to one of the plurality of third electrodes; and
a second non-polar liquid disposed between the first and second substrates, wherein the second barrier layer is disposed between the polar liquid and the plurality of the third electrodes, and the second non-polar liquid is in direct contact with the second barrier layer in each pixel region.

8. The device of claim 7, wherein the plurality of first electrodes serves as a common electrode, and each second electrode and each third electrode are respectively connected to two pixel electrodes or a corresponding source in two thin film transistor arrays.

9. The device of claim 7, wherein the plurality of second electrodes serves as a common electrode, and each first electrode and each third electrode are respectively connected to two pixel electrodes or a corresponding source in two thin film transistor arrays.

10. The device of claim 7, wherein the first or second non-polar liquid comprises a color liquid, and the first or second non-polar liquid in different pixel regions have the same color or different colors.

11. The device of claim 7, wherein the first or second non-polar liquid comprises a color liquid, and the first non-polar liquid and the second non-polar liquid in the same pixel region have the same color or different colors.

12. The device of claim 7, wherein the first or second barrier layer has a treated hydrophobic surface and comprises silicon oxide, silicon nitride, silicon oxynitride, Al₂O₃, Ta₂O₃, TiO₂, BaTiO₃, polyvinylidene difluoride (PVDF), or combinations thereof.

13. The device of claim 7, wherein the first or second barrier layer comprises fluoro-containing polymer, polytetrafluoroethene (PTFE) or diamond-like carbon.

14. The device of claim 1, wherein the first or second barrier layer has a treated hydrophobic surface and comprises silicon oxide, silicon nitride, silicon oxynitride, Al₂O₃, Ta₂O₃, TiO₂, BaTiO₃, polyvinylidene difluoride (PVDF), or combinations thereof.

15. The device of claim 1, wherein the first or second barrier layer comprises fluoro-containing polymer, polytetrafluoroethene (PTFE) or diamond-like carbon.

16. An electro-wetting display device, comprising:
a first substrate and a second substrate disposed opposite thereto;
a plurality of first electrodes and a plurality of second electrodes corresponding thereto, disposed on the first substrate and facing the second substrate;
a first barrier layer disposed on the first substrate and between the plurality of first electrodes and the plurality of second electrodes;
a plurality of first ribs disposed on the first substrate to form a plurality of pixel regions, wherein each pixel region corresponds to one of the plurality of first electrodes and one of the plurality of second electrodes, and the second electrode in each pixel region is disposed above the corresponding first electrode to form an overlapping region as viewed from a top-view perspective therebetween; and
a polar liquid and a first non-polar liquid disposed between the first and second substrates, wherein the first non-polar liquid is in direct contact with the first barrier layer in each pixel region.

17. The device of claim 16, wherein the first barrier layer is disposed between the polar liquid and at least one of the plurality of first electrodes and the plurality of second electrodes.

18. The device of claim 16, wherein an area ratio of the overlapping region as viewed from a top-view perspective to a corresponding pixel region is not less than ⅕.

19. The device of claim 16, wherein the second substrate further comprises a solar cell, color filter, light guide plate or flat panel display thereon.

20. The device of claim 16, wherein one of the plurality of first electrodes and the plurality of second electrodes serves as a common electrode and the other serves as a pixel electrode.

21. The device of claim 16, further comprising:
a plurality of third electrodes disposed on the second substrate and facing the first substrate;
a second barrier layer disposed on the second substrate and covering the plurality of third electrodes;
a plurality of second ribs disposed on the second substrate and facing to the plurality of first ribs, wherein each pixel region corresponds to one of the plurality of third electrodes; and
a second non-polar liquid disposed between the first and second substrates, wherein the second barrier layer is disposed between the polar liquid and the plurality of the third electrodes, and the second non-polar liquid is in direct contact with the second barrier layer in each pixel region.

22. The device of claim 21, wherein the plurality of first electrodes serves as a common electrode, and each second electrode and each third electrode are respectively connected to two pixel electrodes or a corresponding source in two thin film transistor arrays.

23. The device of claim 21, wherein the plurality of second electrodes serves as a common electrode, and each first electrode and each third electrode are respectively connected to two pixel electrodes or a corresponding source in two thin film transistor arrays.

24. The device of claim 21, wherein the first or second non-polar liquid comprises a color liquid, and the first or second non-polar liquid in different pixel regions have the same color or different colors.

25. The device of claim 21, wherein the first or second non-polar liquid comprises a color liquid, and the first non-polar liquid and the second non-polar liquid in the same pixel region have the same color or different colors.

26. The device of claim 21, wherein the first or second barrier layer has a treated hydrophobic surface and comprises silicon oxide, silicon nitride, silicon oxynitride, Al₂O₃, Ta₂O₃, TiO₂, BaTiO₃, polyvinylidene difluoride (PVDF), or combinations thereof.

27. The device of claim 21, wherein the first or second barrier layer comprises fluoro-containing polymer, polytetrafluoroethene (PTFE) or diamond-like carbon.

28. The device of claim 16, wherein the first or second barrier layer has a treated hydrophobic surface and comprises silicon oxide, silicon nitride, silicon oxynitride, Al₂O₃, Ta₂O₃, TiO₂, BaTiO₃, polyvinylidene difluoride (PVDF), or combinations thereof.

29. The device of claim 16, wherein the first or second barrier layer comprises fluoro-containing polymer, polytetrafluoroethene (PTFE) or diamond-like carbon.

30. An electro-wetting display device, comprising:
a first substrate and a second substrate disposed opposite thereto;
a plurality of first electrodes and a plurality of second electrode thick layers corresponding thereto, disposed on the first substrate and facing the second substrate;
a first barrier layer covering the plurality of first electrodes and the plurality of second electrode thick layers and disposed between the plurality of first electrodes and the plurality of second electrode thick layers;
a plurality of first ribs disposed on the first substrate to form a plurality of pixel regions, wherein each pixel region corresponds to one of the plurality of first electrodes and one of the plurality of second electrode thick layers; and
a polar liquid and a first non-polar liquid disposed between the first and second substrates, wherein the first non-polar liquid is in direct contact with the first barrier layer in each pixel region.

31. The device of claim 30, wherein the first barrier layer is disposed between the polar liquid and at least one of the plurality of first electrodes and the plurality of second electrode thick layers.

32. The device of claim 30, wherein one of the plurality of first electrodes and the plurality of second electrode thick layers serves as a common electrode and the other serves as a pixel electrode.
